(19) United States
(12) Patent Application Publication
(10) Pub. No.: US 2021/0219525 A1
(43) Pub. Date: Jul. 22, 2021

(54) A PAINT APPLICATOR, AND A METHOD FOR APPLYING PAINT TO A SURFACE

(71) Applicant: AGRIFY SOLUTIONS LIMITED, Mallow, County Cork (IE)

(72) Inventors: William Martin O'KEEFFE, Mallow (IE); Philip Edwin MIESLE, Ennis (IE); David Gerard O'KEEFFE, Quin (IE)

(73) Assignee: AGRIFY SOLUTIONS LIMITED, Mallow, County Cork (IE)

(21) Appl. No.: 17/059,054

(22) PCT Filed: May 31, 2019
(86) PCT No.: PCT/IE2019/000006

§ 371 Date: Nov. 25, 2020

(30) Foreign Application Priority Data
May 31, 2018 (IE) S2018/160

(51) Int. Cl. A01K 29/00; A01K 11/00; B05C 17/02

(52) U.S. Cl. CPC A01K 29/005; B05C 17/0357; B05C 17/0217; A01K 11/006

(57) ABSTRACT

A paint applicator (1) comprises a housing (3) defining a hollow interior region (4) having a circumferentially extending inner arcuate surface (20). A roller (5) provided with a circumferentially extending paint transfer surface (34) is rotatably mounted in the housing (3) about a rotational axis (7). A paint container (9) releasably secured to an inlet port (35) in the housing (3) communicates the paint container (9) with a communicating recess (37) formed into the inner arcuate surface (20) of the housing (3). The communicating recess (37) communicates the paint transfer surface (34) of the roller (5) with paint from the paint container (9) through the inlet port (35). The paint transfer surface (34) of the roller (5) cooperates with the inner arcuate surface (20) of the housing (3) in order to form a seal around the periphery of the communicating recess (37) when the roller (5) is stationary in the housing (3) to seal the paint in the communicating recess (37).

The present invention relates to a paint applicator, and the invention also relates to a method for applying paint to a surface, and in particular, though not limited, to a method for applying paint to a tail, back or rear portion of an animal in order to identify the onset of oestrus in an animal.

It is known to paint the tail or back of an animal adjacent the rear thereof, typically, a cow or a heifer, in order to detect the onset of oestrus in the animal. The paint, generally is a water-based paint, but may be an oil based paint, which over time wears off the animal. The painting of the tail or back of an animal to detect oestrus is based on the fact that on the onset of oestrus in an animal, that animal is typically mounted by other animals in a herd, which may also be cows or heifers. Once an animal, the tail or back of which has been painted, is mounted by another animal, either the paint on the mounted animal will be marked, soiled or partly worn off the animal by the action of the mounting animal. Accordingly, by periodically inspecting the paint on the tail or back of an animal, one can detect if the animal has been mounted, which in turn would be an indication of the onset of oestrus.

In general, paint is applied to the tail or back of the animal by a brush, which is dipped into a container of the paint. The paint container must be open, with the possibility of the container being kicked over by an animal. Alternatively, the paint may be supplied in a relatively small bottle which may be provided with a brush applicator attached to the bottle for applying the paint from the bottle through the brush applicator. In order to paint the tail or back of the animal with a brush or such a bottle applicator, it is essential that the farmer be beside the animal or to the rear of the animal. This is not always possible in a herd of animals, and in general, is inconvenient. There is therefore a need for a paint applicator which addresses this problem, and there is also a need for a paint applicator for applying paint too difficult to access surfaces.

The present invention is directed towards a paint applicator, and the invention is also directed towards a method for applying paint to a tail, a back or a rear portion of an animal.

According to the invention there is provided a paint applicator comprising a housing defining a hollow interior region, a roller rotatably mounted in the housing about a longitudinally extending rotational axis and having a circumferentially extending paint transfer surface, the housing defining an open mouth providing access to the paint transfer surface of the roller, an inlet port in the housing to accommodate paint therethrough, a communicating recess formed in the housing communicating the inlet port with the paint transfer surface of the roller, the transfer surface of the roller cooperating with the interior of the housing to substantially form a seal with the housing around the communicating recess.

The invention also provides a paint applicator a paint applicator comprising a housing defining a hollow interior region, a roller rotatably mounted in the housing about a longitudinally extending rotational axis and having a circumferentially extending paint transfer surface, the housing defining an open mouth providing access to the paint transfer surface of the roller, an inlet port in the housing to accommodate paint to the transfer surface of the roller, a paint container coupleable to the inlet port, the paint container cooperating with the inlet port for feeding paint from the container to the paint transfer surface of the roller.

Preferably, the paint container is configured for feeding paint therefrom to the paint transfer surface of the roller under gravity.

In one embodiment of the invention a communicating recess is formed in the housing and communicates the inlet port with the paint transfer surface of the roller.

In another embodiment of the invention the communicating recess is located in the housing substantially centrally in a longitudinal direction parallel to the rotational axis of the roller.

In another embodiment of the invention the communicating recess extends in the housing in the direction parallel to the rotational axis of the roller a distance in the range of forty percent to ninety percent of the length of the roller. Preferably, the communicating recess extends in the housing in the direction parallel to the rotational axis of the roller a distance of at least sixty percent of the length of the roller. Advantageously, the communicating recess extends in the housing in the direction parallel to the rotational axis of the roller a distance of at least seventy percent of the length of the roller. Preferably, the communicating recess extends in the housing in the direction parallel to the rotational axis of the roller a distance of at least seventy-five percent of the length of the roller. Ideally, the communicating recess extends in the housing in the direction parallel to the rotational axis of the roller a distance of approximately eighty percent of the length of the roller.

In one embodiment of the invention the communicating recess extends circumferentially in the housing partly around the circumference of the roller. Preferably, the communicating recess extends circumferentially in the housing partly around the circumference of the roller an angular distance in the range of 10° to 140°. Advantageously, the communicating recess extends circumferentially in the housing partly around the circumference of the roller an angular distance in the range of 20° to 120°. Preferably, the communicating recess extends circumferentially in the housing partly around the circumference of the roller an angular distance in the range of 30° to 90°. Ideally, the communicating recess extends circumferentially in the housing partly around the circumference of the roller an angular distance of approximately 60°.

In one embodiment of the invention the hollow interior region of the housing is defined by a circumferentially extending inner surface of the housing, the circumferentially extending inner surface of the housing defining a longitudinally extending main central axis, and the rotational axis of the roller substantially coincides with the main central axis.

In another embodiment of the invention the circumferentially extending inner surface of the housing comprises an arcuate inner surface.

In a further embodiment of the invention the communicating recess extends into the circumferentially extending inner surface of the housing.

In one embodiment of the invention the paint transfer surface of the roller cooperates with the circumferentially extending inner surface of the housing adjacent the communicating recess to form the seal with the housing around the communicating recess.

In another embodiment of the invention the radius of the circumferentially extending inner surface of the housing from the main central axis thereof adjacent the communicating recess is not more than 1 mm greater than the radius of the paint transfer surface of the roller from the rotational axis thereof. Preferably, the radius of the circumferentially extending inner surface of the housing from the main central axis thereof adjacent the communicating recess is not more than 0.5 mm greater than the radius of the paint transfer surface of the roller from the rotational axis thereof. Advantageously, the radius of the circumferentially extending inner surface of the housing from the main central axis thereof adjacent the communicating recess is not more than 0.25 mm greater than the radius of the paint transfer surface of the roller from the rotational axis thereof. Preferably, the radius of the circumferentially extending inner surface of the housing from the main central axis thereof adjacent the communicating recess is not more than 0.1 mm greater than the radius of the paint transfer surface of the roller from the rotational axis thereof.

Ideally, the radius of the circumferentially extending inner surface of the housing from the main central axis thereof adjacent the communicating recess is substantially similar to the radius of the paint transfer surface of the roller from the rotational axis thereof.

In another embodiment of the invention the circumferentially extending inner surface of the housing extends circumferentially around the roller an angular distance in the range of 150° to 210°. Preferably, the circumferentially extending inner surface of the housing extends circumferentially around the roller an angular distance in the range of 160° to 200°. Advantageously, the circumferentially extending inner surface of the housing extends circumferentially around the roller an angular distance in the range of 170° to 195°.

Preferably, the circumferentially extending inner surface of the housing extends circumferentially around the roller an angular distance of approximately 195°. Alternatively, the circumferentially extending inner surface of the housing extends circumferentially around the roller an angular distance of approximately 190°.

In one embodiment of the invention the circumferentially extending inner surface of the housing terminates at its respective circumferential opposite sides in longitudinal extending side edges defining the open mouth to the hollow interior region and exposing the paint transfer surface of the roller.

In another embodiment of the invention the longitudinally extending side edges defining the open mouth extend substantially parallel to each other, and substantially parallel to the rotational axis of the roller.

Preferably, the longitudinally extending side edges defining the open mouth extend substantially parallel to the main central axis.

In one embodiment of the invention the open mouth extends circumferentially around the roller an angular distance in the range of 150° to 210°. Preferably, the open mouth extends circumferentially around the roller an angular distance in the range of 160° to 200°. Advantageously, the open mouth extends circumferentially around the roller an angular distance in the range of 165° to 190°.

In one embodiment of the invention the open mouth extends circumferentially around the roller an angular distance of approximately 165°. Alternatively, the open mouth extends circumferentially around the roller an angular distance of approximately 170°.

Preferably, the open mouth extends substantially the length of the roller.

In one embodiment of the invention the inlet port defines a central inlet axis.

Preferably, the central inlet axis defined by the inlet port extends substantially perpendicularly to the rotational axis of the roller.

In one embodiment of the invention the central inlet axis defined by the inlet port intersects the rotational axis of the roller. Preferably, the central inlet axis intersects the rotational axis of the roller substantially midway along the length of the roller.

Advantageously, the central inlet axis substantially bisects the angle through which the circumferentially extending inner surface of the housing extends circumferentially around the roller.

In one embodiment of the invention the roller is rotatably mounted on a roller shaft. Preferably, the roller shaft extends longitudinally through the hollow interior region of the housing. Advantageously, the roller shaft defines the rotational axis of the roller.

In one embodiment of the invention the roller shaft is carried in the housing. Preferably, the roller shaft is carried in and extends between a pair of end walls longitudinally spaced apart along the rotational axis of the roller.

In another embodiment of the invention the roller comprises a cylindrical drum defining an outer circumferential surface, and a paint transfer means defining the paint transfer surface located on and extending circumferentially around the outer circumferential surface of the cylindrical drum. Preferably, the paint transfer means comprises a fabric material. Advantageously, the paint transfer means comprises a fine mat material. Advantageously, the paint transfer means comprises a high density knit fabric material.

Preferably, the inlet port is configured for receiving a paint container, and for accommodating paint from the paint container to the communicating recess. Preferably, the paint container is coupled to the inlet port. Advantageously, the paint container is releasably coupled to the inlet port.

In one embodiment of the invention the paint container comprises an enclosed container having an outlet port configured for coupling to the inlet port of the housing.

In another embodiment of the invention the outlet port of the container is configured for releasably coupling to the inlet port of the housing.

In another embodiment of the invention the container comprises one of a rigid and a semi-rigid material.

In another embodiment of the invention a support structure is provided for supporting the container, the support structure being located adjacent the inlet port. Preferably, the support structure extends from the housing around the inlet port. Advantageously, the support structure is configured for maintaining the container relative to the inlet port, so that the paint is fed from the container into the inlet port. Preferably, the support structure is configured for maintaining the container relative to the inlet port so that the paint is fed from the container into the inlet port under gravity.

In one embodiment of the invention the support structure is releasably coupleable to the housing.

In another embodiment of the invention the container comprises a flexible material. Preferably, the flexible material of the container is configured so that as the volume of paint in the container reduces, the internal volume of the container reduces substantially proportionally with the reduction in the volume of paint therein.

Advantageously, the flexible material of the container is configured so that the internal volume of the container remains substantially equal to the volume of paint therein.

In one embodiment of the invention the housing is carried on a carrier shaft. Preferably, the carrier shaft is releasably coupleable to the housing.

In another embodiment of the invention the carrier shaft is coupled to the housing at a location substantially midway between the ends of the roller.

In one embodiment of the invention the carrier shaft terminates at a distal end thereof in a handgrip means. Preferably, the handgrip means comprises a first handgrip element extending longitudinally along a distal end of the carrier shaft.

In another embodiment of the invention the handgrip means comprises a second handgrip element located adjacent the first handgrip element extending substantially transversely relative to the first handgrip element. Preferably, the second handgrip element is located between the carrier shaft and the first handgrip element. Advantageously, the second handgrip element is spaced apart radially from the carrier shaft.

In another embodiment of the invention a connecting means is provided for connecting the second handgrip element to the carrier shaft.

In one embodiment of the invention the carrier shaft is pivotally coupled to the housing about a first pivot axis, and the angular position of the carrier shaft relative to the housing is adjustable about the first pivot axis. Preferably, the first pivot axis extends substantially parallel to the central inlet axis defined by the inlet port.

In another embodiment of the invention the carrier shaft comprises a proximal shaft portion and a distal shaft portion, the proximal shaft portion being coupled to the housing. Preferably, the distal shaft portion is pivotally coupled to the proximal shaft portion about a second pivot axis. Advantageously, the second pivot axis extends in a general direction at an angle greater than zero to the first pivot axis. Preferably, the second pivot axis extends orthogonally relative to the first pivot axis.

In another embodiment of the invention the angular relationship of the distal shaft portion with the proximal shaft portion is adjustable about the second pivot axis.

Preferably, the handgrip means is located on the distal shaft portion adjacent a distal end thereof.

Further the invention provides a method for applying paint to a surface, the method comprising providing a paint applicator as claimed in any preceding claim, setting the carrier shaft relative to the housing, so that when the handgrip means is held for operating the paint applicator, the paint container is located above the housing, charging the paint container with paint and securing the paint container to the inlet port, urging the roller into engagement with the surface to be painted, and urging the roller along the surface to be painted, so that the roller rotates to transfer the paint from the paint container to the surface to be painted.

In one embodiment of the invention the paint applicator is configured for applying paint to an animal. Preferably, the paint applicator is configured for applying paint to one or both of a tail and a rear part of the back of the animal. Advantageously, the paint applicator is configured for applying paint to an animal for detecting the onset of oestrus in the animal.

In another embodiment of the invention the animal is one of a cow and a heifer.

Preferably, the method further comprises periodically checking if the paint applied to the animal has been disturbed as a result of the animal having been mounted by another animal.

The advantages of the invention are many. A particularly important advantage of the invention is that it provides an easy, quick and convenient method for applying paint to the tail or the top of the back portion of an animal to the rear thereof, for example, a cow or a heifer in order to provide an indication of the onset of oestrus in the animal. By periodically checking the paint on the animal after it has been applied to the tail or to the back of the animal, a farmer can detect the onset of oestrus in an animal. Oestrus would be indicated if the paint has been marked, soiled or disturbed, which typically would occur as a result of the painted animal being mounted by another animal, thus indicating the onset of Oestrus in the painted animal.

A particularly important advantage of the invention is achieved by virtue of the fact that the paint transfer surface of the roller cooperates with the interior of the housing to substantially form a seal with the housing around the communicating recess. This provides the advantage that there is no need to remove the container from the applicator between uses, since once the roller is stationary in the housing, the roller forms a seal around the communicating recess, thereby sealing the paint in the communicating recess. Accordingly, there is no need to take any action in connection with preventing leaking of paint from the paint applicator between applications of paint from one animal to the next. Furthermore, on completion of painting the animals in a herd, the paint applicator may be stored with the paint container coupled to the paint applicator, with no danger of paint leaking from the paint applicator.

Another advantage of the invention is that the paint applicator may be used for applying paint to any surface, and is particularly suitable for applying paint to surfaces which are difficult to access.

The use of pipes and pipe fittings of plastics material for forming the proximal and distal shaft portions of the paint applicator also provides an advantage, in that firstly, the shaft portions can be readily easily assembled, and additionally, can be readily easily adjusted so that irrespective of the position of a farmer relative to an animal to be painted, the position and orientation of the paint applicator relative to the animal can be adjusted relative to the handgrip means, so that a farmer by holding the paint applicator by the handgrip means can readily operate the paint applicator to apply paint accurately to a tail or the back of an animal adjacent the rear of the animal. A further advantage of the invention is that the adjustment provided between the paint applicator and the handgrip means is virtually infinite.

The invention will be more clearly understood from the following description of some preferred embodiments thereof which are given by way of example only with reference to the accompanying drawings, in which:

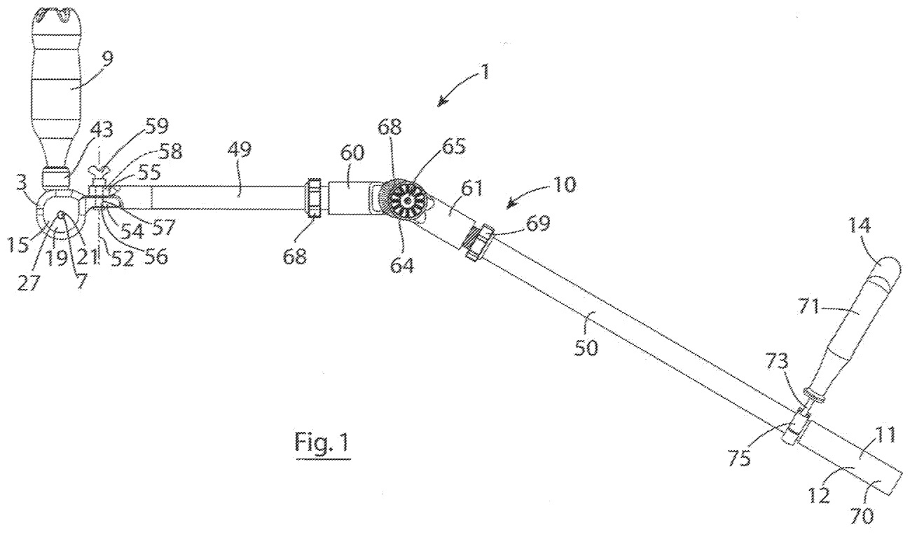

FIG. 1 is a side elevational view of a paint applicator according to the invention,

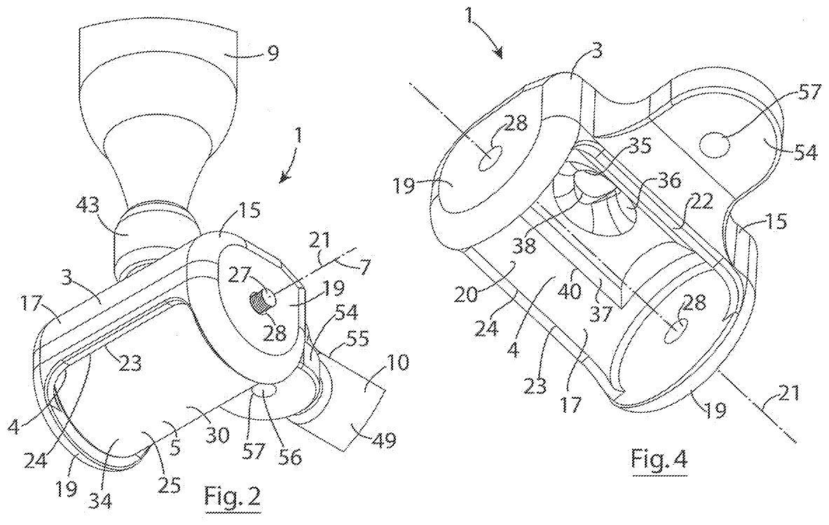

FIG. 2 is a perspective view of a portion of the paint applicator of FIG. 1,

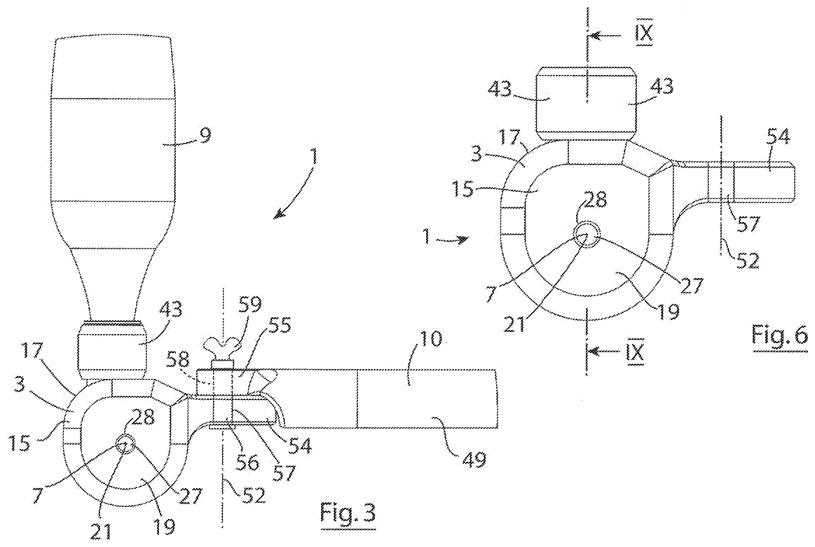

FIG. 3 is a side elevational view of the portion illustrated in FIG. 2 of the paint applicator of FIG. 1,

FIG. 4 is a perspective view of a detail of the paint applicator of FIG. 1,

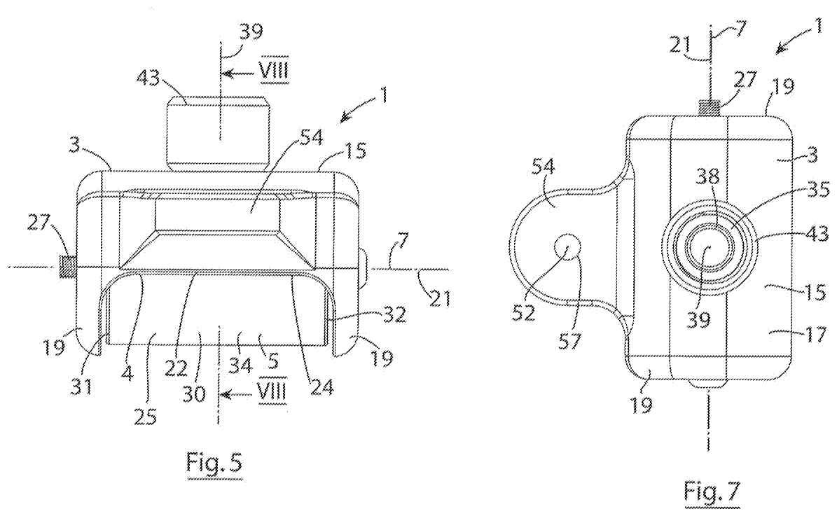

FIG. 5 is a rear end elevational view of a part of the portion of FIG. 2 of the paint applicator of FIG. 1,

FIG. 6 is a side elevational view of the portion of FIG. 5 of the paint applicator of FIG. 1,

FIG. 7 is a top plan view of the portion of FIG. 5 of the paint applicator of FIG. 1,

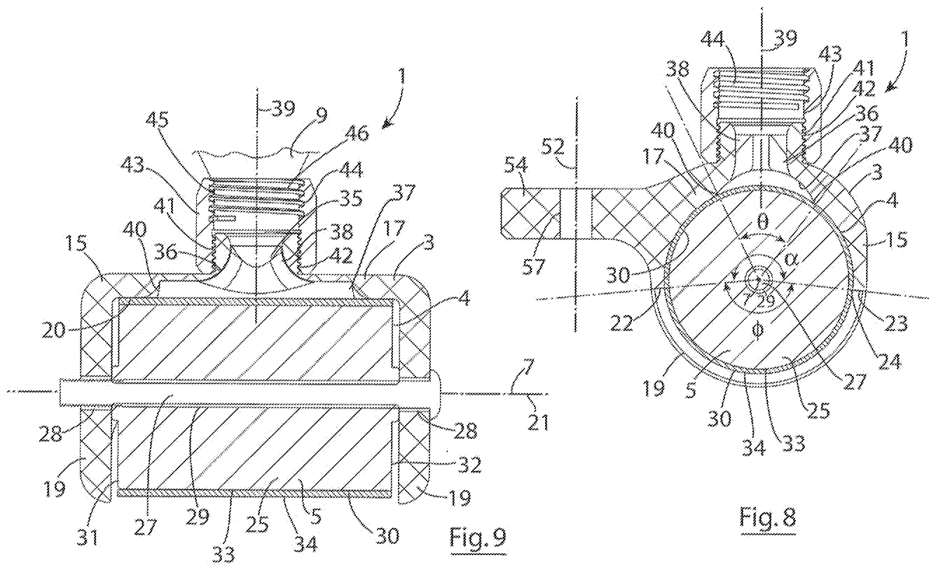

FIG. 8 is a transverse cross-sectional side elevational view of the portion of FIG. 5 of the paint applicator of FIG. 1 on the line VIII-VIII of FIG. 5,

FIG. 9 is a cross-sectional rear end elevational view of the portion of FIG. 5 of the paint applicator of FIG. 1 on the line IX-IX of FIG. 6,

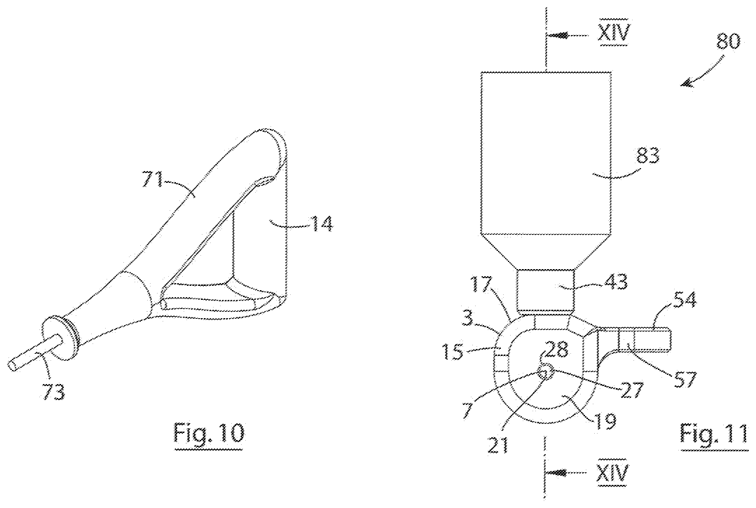

FIG. 10 is a perspective view of another detail of the paint applicator of FIG. 1,

FIG. 11 is a side elevational view of a portion of a paint applicator according to another embodiment of the invention,

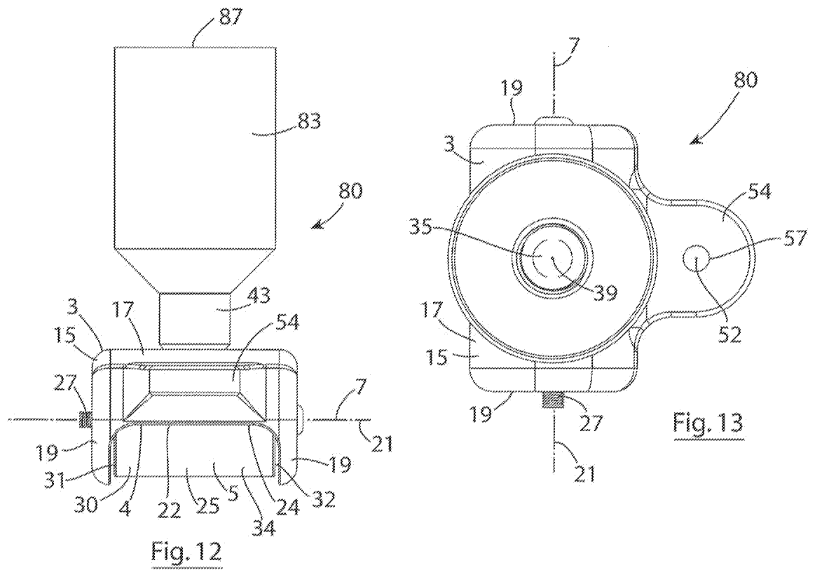

FIG. 12 is a rear end elevational view of the portion of the paint applicator of FIG. 11,

FIG. 13 is a top plan view of the portion of the paint applicator of FIG. 11 according to this embodiment of the invention,

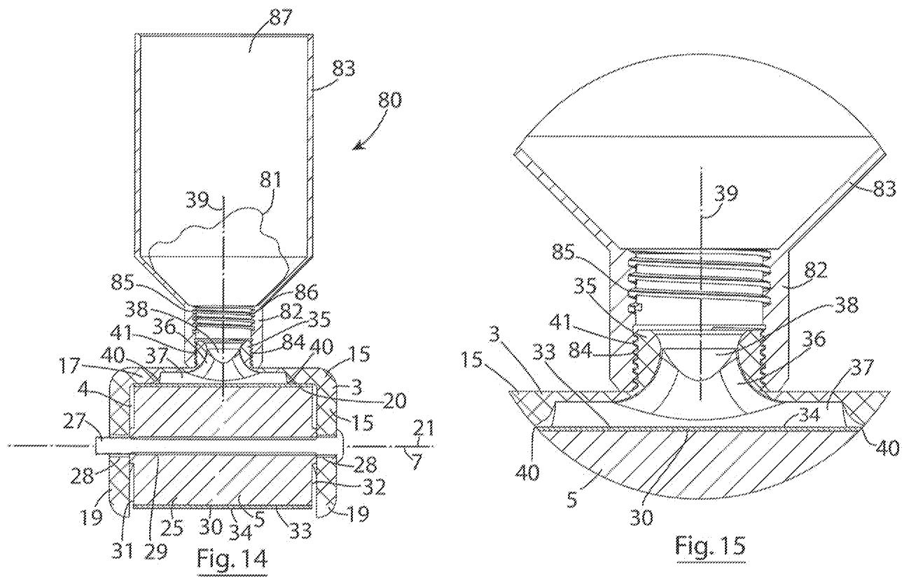

FIG. 14 is a cross-sectional rear end elevational view of the portion of the paint applicator of FIG. 11 on the line XIV-XIV of FIG. 11, and

FIG. 15 is an enlarged cross-sectional rear end elevational view of a detail of the portion of the paint applicator of FIG. 11.

Referring to the drawings and initially to FIGS. 1 to 10 thereof, there is illustrated a paint applicator according to the invention indicated generally by the reference numeral 1. The paint applicator 1 is particularly suitable for applying paint to an animal, and in particular, for applying paint to a tail or the rear portion of the back of an animal for detecting the onset of oestrus in an animal, for example, in a cow or a heifer. However, the paint applicator 1 is also suitable for applying paint to any surface, and in particular, though not limited to surfaces which are difficult to access either internally or externally of a building. The paint applicator 1 comprising a housing 3 defining a hollow interior region 4 within which a roller 5 is rotatably mounted about a longitudinally extending rotational axis 7. A paint container 9 is releasably coupleable to the housing 3 for applying paint to the roller 5 for transfer to a surface to be painted. The housing 3 is carried on a carrier shaft 10 which terminates at a distal end 11 in a handgrip means which comprises a first handgrip element 12 and a second handgrip element 14, as will be described in more detail below, for gripping and holding the paint applicator 1 during application of the paint to the surface to be painted.

Turning initially to the housing 3, the housing 3 comprises a body member 15 which defines the hollow interior region 4. The body member 15 comprises an arcuate portion 17 which terminates at its respective opposite ends in a pair of end walls 19. The arcuate portion 17 defines a circumferentially extending inner arcuate surface 20, which together with the end walls 19 defines the hollow interior region 4. The inner arcuate surface 20 is partly cylindrical and defines a longitudinally extending main central axis 21, with which the rotational axis 7 of the roller 5 substantially coincides. The inner arcuate surface 20 extends circumferentially around the main central axis 21 an angular distance, namely, through an angle α of approximately 195° about the main central axis 21, and terminates in its respective circumferentially opposite sides in longitudinally extending spaced apart parallel side edges, namely, a longitudinally extending proximal side edge 22, and a longitudinally extending distal side edge 23. Accordingly, the inner arcuate partly cylindrical surface 20 of the housing 3 extends circumferentially between the proximal and distal side edges 22 and 23 around the main central axis 21 the angular distance a of 195°.

The proximal and distal side edges 22 and 23 extend parallel to the main central axis 21 and define with the end walls 19 an open mouth 24 to the hollow interior region 4 to provide access thereto and to expose the roller 5. The open mouth 24 extends around the main central axis 21 an angular distance, namely, through an angle π of approximately 165°. It is envisaged that in some embodiments of the invention that the inner arcuate surface 20 of the housing 3 may extend circumferentially around the main central axis 21 between the proximal and distal side edges 22 and 23 an angle α of less than 195°, and in some embodiments of the invention it is envisaged that the angle α may be 180°, which in turn, would result in the angle π of the open mouth being also approximately 180°. It will also be appreciated that the angle α through which the inner arcuate surface 20 extends around the main central axis 21 between the proximal and distal side edges 22 and 23, may be less than 180°, in which case, the angle π of the open mouth would be greater than 180°.

Turning now to the roller 5, the roller 5 comprises a cylindrical drum 25, which may be solid or hollow, but in this embodiment of the invention is hollow of plastics material. A roller shaft 27 extending through bores 28 in the respective end walls 19 extends through a bore 29 of the roller 5 and rotatably carries the roller 5 thereon about the rotational axis 7 which is defined by the roller shaft 27. The roller shaft 27 is engaged fast, in other words non-rotatably in the bores 28 in the end walls 19, but may if desired also be rotatable in the bores 28.

A paint transfer means, which in this embodiment of the invention comprises a paint transfer skin 30, extends circumferentially completely around the outer circumferential surface 33 of the cylindrical drum 25 of the roller 5 and along the outer circumferential surface 33 of the cylindrical drum 25 from one end 31 thereof to the other end 32 of the cylindrical drum 25. The paint transfer skin 30 defines a paint transfer surface 34 for transferring paint from the paint container 9 to the surface to be painted as will be described in more detail below. In this embodiment of the invention the paint transfer skin 30 comprises a fine fabric material, which in this case comprises a high density knit fabric material. However, it will be readily apparent to those skilled in the art that the paint transfer surface 34 may be formed by any other suitable paint transfer material, and indeed, in some embodiments of the invention it is envisaged that the paint transfer means may be provided by a covering or skin of a suitable open cell foamed plastics material extending completely circumferentially around the outer circumferential surface 33 of the cylindrical drum 25 and along the length of the cylindrical drum 25 from one end 31 to the other end 32 thereof. Alternatively, the roller may be formed entirely from a suitable foamed plastics material, which would itself define the paint transfer surface.

In this embodiment of the invention the roller 5 is a relatively short roller and is of axial length between the ends 31 and 32 thereof of approximately 80 mm, although, it is envisaged that in some embodiments of the invention the axial length of the roller 5 may be of any suitable length, and typically, of the range between 60 mm to 100 mm, although preferably, the axial length of the roller would lie in the range of 75 mm to 85 mm. The diameter of the paint transfer surface 34 of the roller 5 in this embodiment of the invention is approximately 65 mm, although, it is envisaged in some embodiments of the invention the diameter of the roller to the paint transfer surface 34 may be of any suitable diameter, typically, in the range of 30 mm to 90 mm and preferably, in the range of 50 mm to 60 mm.

An inlet port 35 is formed in the body member 15 of the housing 3 for accommodating paint from the paint container 9 to the paint transfer surface 34 of the roller 5. The inlet port 35 terminates in the hollow interior region 4 of the housing 3 in a communicating recess 37 formed into the inner arcuate surface 20 of the housing 3 to a depth of approximately 3 mm, and in general, would be of depth in the range of 1 mm to 7 mm, and preferably, would be of depth in the range of 2 mm to 5 mm. In this embodiment of the invention the communicating recess 37 extends longitudinally along the inner arcuate surface 20 and is centred longitudinally relative to the roller 5 and extends approximately seventy percent of the length of the roller 5 between the ends 31 and 32 thereof.

The communicating recess 37 extends circumferentially around the inner arcuate surface 20 of the housing 3 about the main central axis 21, and in this embodiment of the invention extends an angular distance 9 around the main central axis 21 of the hollow interior region 4 of approximately 60°. The communicating recess 37 is substantially centred between the proximal and distal side edges 22 and 23 of the housing 3. While in this embodiment of the invention the angle θ through which the communicating recess 37 extends circumferentially around the inner arcuate surface 20 of the housing 3 about the main central axis 21 has been described as being 60°, it is envisaged that the angle θ through which the communicating recess 37 extends circumferentially around the inner arcuate surface 20 of the housing 3 about the main central axis 21 may be of any suitable value, and the angle θ may in some cases lie in the range of 10° to 140°, although in general, it is preferably that the angle θ should lie in the range of 30° to 90°.

The inlet port 35 defines an inlet bore 38 to the communicating recess 37 which diverges outwardly into the communicating recess 37 at 36 for distributing the paint into the communicating recess 37. The bore 38 of the inlet port 35 defines a central inlet axis 39 which extends substantially perpendicularly to the main central axis 21, and in turn to the rotational axis 7 of the roller 5 and intersects the rotational axis 7 of the roller 5 substantially midway between the opposite ends 31 and 32 of the roller 5. Additionally, the central inlet axis 39 bisects the angle α through which the inner arcuate surface 20 of the housing 3 extends between the proximal and distal side edges 22 and 23.

In this embodiment of the invention as discussed above the main central axis 21 of the hollow interior region 4 coincides with the rotational axis 7 of the roller 5. The radius of the inner arcuate surface 20 of the housing 3 from the main central axis 21 is substantially similar to the radius of the paint transfer surface 34 of the roller 5 defined by the paint transfer skin 30 from the rotational axis 7 of the roller 5, so that the paint transfer surface 34 bears on the inner arcuate surface 20 of the hollow interior region 4, and therefore forms with the inner arcuate surface 20 a seal around the periphery 40 of the communicating recess 37 for sealing the communicating recess 37 from the hollow interior region 4 when the roller 5 is not rotating. The clearance between the inner arcuate surface 20 of the housing 3 and the paint transfer surface 34 of the roller 5 should not exceed 1 mm, and preferably, should not exceed 0.5 mm, and advantageously, should not exceed 0.25 mm, and ideally, should not exceed 0.1 mm, in order to maintain the seal between the paint transfer surface 34 and the inner arcuate surface 20 around the periphery 40 of the communicating recess 37. In this embodiment of the invention, since the radius of the paint transfer surface 34 from the rotational axis 7 of the roller 5 is approximately 32.5 mm, the radius of the inner arcuate surface 20 from the main central axis 21 is also approximately 32.5 mm in order to produce a clearance of 0 mm between the paint transfer surface 34 and the inner arcuate surface 20.

The inlet port 35 is externally threaded at 41 for engaging proximal internal threads 42 in an adapter sleeve 43 for securing the adapter sleeve 43 to the inlet port 35. The adapter sleeve 43 is also provided with distal internal threads 44 for engaging corresponding external threads 45 on an outlet port 46 of the paint container 9 for securing the paint container 9 to the housing 3 for accommodating paint from the paint container 9 through the outlet port 46 thereof and the inlet port 35 of the housing 3 into the communicating recess 37 for in turn transfer onto the paint transfer surface 34 of the paint transfer skin 30 of the roller 5.

In this embodiment of the invention the paint container is of a rigid or a semi-rigid plastics material, and typically, is of capacity of approximately 750 mL, but may be of capacity in the range of 500 mL to 2,000 mL.

Turning now to the carrier shaft 10, the carrier shaft 10 in this embodiment of the invention comprises a proximal shaft portion 49 and a distal shaft portion 50, both of which are constructed of pipes and fittings of plastics material, of the type commonly used as drain pipes for water, and typically for piping water from a domestic sink or bath to an external drainage trap. The proximal shaft portion 49 is pivotally coupled to the housing 3 about a first pivot axis 52, which extends substantially parallel to the central inlet axis 39 of the inlet port 38, for adjusting the angular position of the housing 3 relative to the proximal shaft portion 49. A first mounting lug 54 extends from the housing 3 and is engageable with a second mounting lug 55 extending from the proximal end of the proximal shaft portion 49. A first pivot pin 56 extending through first and second bores 57 and 58 in the first and second mounting lugs 54 and 55 pivotally retains the proximal shaft portion 49 pivotally coupled to the housing 3 about the first pivot axis 52. A thumb nut 59 on the first pivot pin 56 secures the first and second mounting lugs 54 and 55 together with the proximal shaft portion 49 at a desired angle to the housing 3. The first mounting lug 54 is located on the housing 3 adjacent the proximal side edge 22 substantially midway between the end walls 19.

The proximal shaft portion 49 terminates in a first coupler 60 adjacent its distal end, and the distal shaft portion 50 terminates in a second coupler 61 adjacent its proximal end. The first and second couplers 60 and 61 are pivotally coupled about a second pivot axis 64 for facilitating adjustment of the angle of the distal shaft portion 50 relative to the proximal shaft portion 49. A second pivot pin 65 extending through the first and second couplers 60 and 61 pivotally couples the first and second couplers 60 and 61 about the second pivot axis 64. A thumb nut 68 secured to the second pivot pin 65 secures the first and second couplers 60 and 61 together with the proximal and distal shaft portions 49 and 50 at a desired angle relative to each other about the second pivot axis 64.

The first coupler 60 is rotatably mounted on the proximal shaft portion 49 for facilitating further adjustment of the angle of the distal shaft portion 50 relative to the proximal shaft portion 49. A first clamping nut 68 secured to the first coupler 60 clamps the first coupler 60 onto the proximal shaft portion 49 with the distal shaft portion 50 at a desired rotational angle relative to the proximal shaft portion 49. The second coupler 61 is also rotatable on the distal shaft portion 50, and a second clamping nut 69 is secured to the second coupler 61 for clamping the second coupler 61 onto the distal shaft portion 50 with the distal and proximal shaft portions 49 and 50 at a desired angle.

The distal shaft portion 50 terminates in the first and second handgrip elements 12 and 14. The first handgrip element 12 extends longitudinally along the distal shaft portion 50 adjacent a distal end 70 thereof. The second handgrip element 14 is carried on a connecting means, in this embodiment of the invention a Y-shaped connector 71 which terminates in a threaded shaft 73 which engages a correspondingly threaded bore (not shown) in a split collar 75 located on the distal shaft portion 50 towards the distal end 70 thereof. The split collar 75 is of the type which is rotatable on the distal shaft portion 50 and can be releasably clamped onto the distal shaft portion 50 with the second handle 14 at a desired angle about the distal shaft portion 50 and with the second handle 14 spaced apart radially from the distal shaft portion 50 and extending transversely thereof.

In this embodiment of the invention the paint is a water based paint, but may also be an oil based paint.

In use, initially the angles of the proximal and distal shaft portions 49 and 50 relative to each other and the angle of the proximal shaft portion 49 relative to the housing 3 are adjusted, so that the angle of the housing 3 relative to the carrier shaft 10, when in use will be such that the paint container 9 will be above the housing 3 to facilitate feeding of the paint from the paint container 9 under gravity to the roller 5. Additionally, the angle of the proximal shaft portion 49 and the distal shaft portion 50 and the angle of the proximal shaft portion 49 with the housing 3 are also set, so that an operator holding the paint applicator 1 by the first and second handgrip elements 12 and 14 will be able to comfortably operate the paint applicator 1 for applying the paint to the surface to which it is to be applied. For example, in a case where the paint is to be applied to the tail or to the top of the back of an animal towards the rear thereof, and the animal is standing in a milking parlour, and the operator is standing in a pit of the milking parlour, the carrier shaft 10 would be adjusted so that the paint roller would engage the tail and the top of the back portion of the animal towards the rear thereof while the operator would stand in the pit. Alternatively, in cases where an animal is held in a crush and an operator would be standing at a substantially similar level to the animal and to one side of the animal, the carrier shaft 10 would be adjusted relative to the housing 3, so that the paint container 9 would be above the housing and the roller would be oriented to engage the tail and the top of the back of the animal towards the rear thereof while the operator is essentially standing beside the animal.

With the carrier shaft 10 appropriately adjusted relative to the housing 3, the paint container 9 is charged with paint and secured by the adapter sleeve 43 to the inlet port 35. The paint applicator 1 is then ready for use, and by holding the paint applicator 1 by the first and second handgrip elements 12 and 14 and applying the roller 5 to the area of the animal or other surface to be painted, as the roller 5 is rolled along the surface to be painted, paint is transferred from the paint container 9 through the inlet port 35 and the communicating recess 37 onto the paint transfer surface 34 of the paint transfer skin 30 of the roller 5, and from the paint transfer surface 34 of the paint transfer skin 30 onto the surface of the animal or other surface to be painted.

On completion of painting, since the roller 5 with the paint transfer surface 34 of the paint transfer skin 30 thereof is configured when not in use to seal the communicating recess 37, there is no need to disengage the paint container 9 from the housing 3.

When the paint applicator 1 is required for use again, the angling of the carrier shaft 10 relative to the housing 3 may if necessary be again adjusted until the angles of the carrier shaft 10 relative to the housing 3 are at the desired angle, and painting can again commence.

It is also envisaged that although not illustrated in the drawings, one or both of the proximal and distal shaft portions 49 and 50 may be configured to be telescoping in order to adjust the length of one or both of the proximal and distal shaft portions 49 and 50.

It is also envisaged that the positon of the second handgrip element 14 along the distal shaft portion 50 may be adjustable.

Referring now to FIGS. 11 to 15 there is illustrated a portion of a paint applicator according to another embodiment of the invention. The portion of the paint applicator according to this embodiment of the invention is indicated generally by the reference numeral 80. The paint applicator 80 is substantially similar to the paint applicator 1, and similar components are identified by the same reference numerals. The carrier shaft 10 of the paint applicator 80, although not illustrated is similar to the carrier shaft 10 of the paint applicator 1. The only difference between the paint applicator 80 and the paint applicator 1 is in the paint container.

In this embodiment of the invention the paint container comprises a paint container of a flexible material, for example, a bag 81 of flexible plastics material. In order to retain the bag 81 in a position above the housing 3 to facilitate feeding of the paint from the bag 81 to the paint transfer surface 34 of the paint transfer skin 30 of the roller 5, a support means is provided, which is provided in the form of a support container 83. The support container 83 terminates in its lower end in a neck 82. A first internal thread 84 is provided in the neck 82 for engaging the external thread 41 of the inlet port 35 and for securing the support container 83 to the housing 3. A second internal thread 85 is provided in the neck 82 of the support container 83 for engaging an externally threaded outlet port 86 of the bag 81, for in turn securing the bag 81 to the inlet port 35. The upper end 87 of the support container 83 is open for accommodating the bag 81 into the support container 83, and for facilitating securing the outlet port 86 of the bag 81 in the second internal threads 85 of the neck 82 of the support container 83.

The consistency of the plastics material of the bag 81 is such that the internal volume of the bag 81 reduces as the volume of paint in the bag 81 reduces, so that the internal volume of the bag 81 is always substantially equal to the volume of paint remaining in the bag 81. This, thus, ensures that the paint flows freely from the bag 81 to the paint transfer surface 34 of the roller 5 without a vacuum being generated within the bag, which would otherwise inhibit the flow of paint from the bag 81 to the paint transfer surface 34 of the roller 5.

Otherwise, the paint applicator 80 is similar to the paint applicator 1, and the use of the paint applicator 80 is also similar to the use of the paint applicator 1.

It will of course be appreciated that while the shaft has been described as being constructed from pipes and pipe fittings of plastics material, any other suitable materials may be used in the construction of the shaft. It will also be appreciated that the joints which join the proximal and distal shafts together, and which join the proximal shaft to the paint applicator may be formed by any other suitable joints, and instead of the joints being secured to the proximal and distal shaft portions by nuts, the joints could be secured by any other suitable securing means, for example, the joints could be provided with quick release securing means, grub screws or the like.

It is also envisaged that a closure element may be provided for closing the open mouth in the applicator which provides access to the roller, so that the open mouth may be closed by the cover when the applicator is not in use. The closure element typically, would be provided as a clip-on closure element which would be configured to releasably clip onto the applicator in order to sealably close the hollow interior region of the housing, in order to further extend the usage period between washing and cleaning of the roller and the hollow interior region of the housing of the applicator.

It is also envisaged that the roller may be provided with a gripping means to improve the grip between the roller and the surface to which the paint is being applied, so that the roller would roll along the surface, without any slippage of the roller along the surface. Such a gripping means may be provided by any suitable friction type or grip type surface, which may be provided at the respective opposite ends of the roller, or centrally intermediate the respective opposite ends of the roller. It is envisaged that a suitable grip means may be of the type which would comprise a plurality of relatively small projections extending from the roller and spaced apart circumferentially around the roller.

While the applicator housing and the roller have been described as being of specific sizes and shapes, and the communicating recess has also been described as being of a specific shape and size, it will be readily apparent to those skilled in the art that housings, rollers and communicating recesses of any other suitable size and shape may be provided.

While the housing of the paint applicator and the roller of the paint applicator have been described as being of plastics material, the housing and the roller may be of any other suitable material. It will also be appreciated that while the paint transfer skin which defines the paint transfer surface of the roller has been described as comprising a fabric material, any other suitable paint transfer skin suitable for defining a paint transfer surface, which would also cooperate with the inner arcuate surface of the housing to form a seal around the communicating recess when the roller is stationary may be provided.

While the communicating recess has been described as extending circumferentially in the housing partly around the circumference of the roller an angular distance of approximately 60°, it is envisaged that the angular distance around which the communicating recess extends around the roller may lie in the range of 10° to 140°, and preferably, from 20° to 120°, and advantageously, from 30° to 90°.

It is envisaged that the circumferentially extending inner arcuate surface of the housing between the proximal and distal side edges thereof may extend through any suitable angle from 150° to 210°, and preferably, from 160° to 200°, and advantageously, from 170° to 195°. It is also envisaged that the angle through which the circumferentially extending inner arcuate surface of the housing extends around the main central axis may be 180° or 190°.

While the pain transfer means has been described as comprising a paint transfer skin of a high density knit fabric material, it is envisaged that the paint transfer skin may comprise fabric material other than high density knit fabric materials, for example, any other suitable fabric or fibrous material.

While the roller has been described as being of a specific length and diameter, it will be readily apparent to those skilled in the art that the roller may be of any suitable length or diameter. However, it will also be appreciated by those skilled in the art for different diameters of rollers, the radius of the inner arcuate surface 20 will have to be altered to accommodate different diameters of rollers, so that the clearance between the paint transfer surface of the roller and the inner arcuate surface of the housing will not exceed 1 mm, and preferably, will not exceed 0.5 mm, and advantageously, will not exceed 0.25 mm, and ideally, should be no more than 0.1 mm, and most ideally, the radius of the paint transfer surface of the roller from the rotational axis of the roller should be substantially similar, if not similar to the radius of the inner arcuate surface of the housing from the main central axis thereof.

It will also be appreciated that any suitable coupling arrangement for coupling the paint container to the inlet port of the housing may be provided, besides providing a threaded adapter sleeve. In some embodiments of the invention, it is envisaged that the paint container may be coupled directly to the inlet port, by being provided with suitable screw threads, a suitable bayonet connection or a suitable snap-fit connection, all of which would be releasable connections. It will also be appreciated that any other suitable support structures for supporting a flexible container may be provided, and other suitable coupling arrangements for coupling the support structure and the flexible container may be provided.

1.-148. (canceled)

149. A paint applicator comprising a housing defining a hollow interior region, a roller rotatably mounted in the housing about a longitudinally extending rotational axis and having a circumferentially extending paint transfer surface, the housing defining an open mouth providing access to the paint transfer surface of the roller, an inlet port in the housing to accommodate paint therethrough, a communicating recess formed in the housing communicating the inlet port with the paint transfer surface of the roller, the transfer surface of the roller cooperating with the interior of the housing to substantially form a seal with the housing around the communicating recess.

150. A paint applicator as claimed in claim 149 in which the communicating recess is located in the housing substantially centrally in a longitudinal direction parallel to the rotational axis of the roller, and preferably, the communicating recess extends in the housing in the direction parallel to the rotational axis of the roller a distance in the range of forty percent to ninety percent of the length of the roller, and advantageously, the communicating recess extends in the housing in the direction parallel to the rotational axis of the roller a distance of at least sixty percent of the length of the roller, and preferably, the communicating recess extends in the housing in the direction parallel to the rotational axis of the roller a distance of at least seventy percent of the length of the roller, and preferably, the communicating recess extends in the housing in the direction parallel to the rotational axis of the roller a distance of at least seventy-five percent of the length of the roller, and advantageously, the communicating recess extends in the housing in the direction parallel to the rotational axis of the roller a distance of approximately eighty percent of the length of the roller, and preferably, the communicating recess extends circumferentially in the housing partly around the circumference of the roller, and advantageously, the communicating recess extends circumferentially in the housing partly around the circumference of the roller an angular distance in the range of 10° to 140°, and preferably, the communicating recess extends circumferentially in the housing partly around the circumference of the roller an angular distance in the range of 20° to 120°, and advantageously, the communicating recess extends circumferentially in the housing partly around the circumference of the roller an angular distance in the range of 30° to 90°, and preferably, the communicating recess extends circumferentially in the housing partly around the circumference of the roller an angular distance of approximately 60°.

151. A paint applicator as claimed in claim 149 in which the hollow interior region of the housing is defined by a circumferentially extending inner surface of the housing, the circumferentially extending inner surface of the housing defining a longitudinally extending main central axis, and the rotational axis of the roller substantially coincides with the main central axis, and preferably, the circumferentially extending inner surface of the housing comprises an arcuate inner surface, and advantageously, the communicating recess extends into the circumferentially extending inner surface of the housing, and preferably, the paint transfer surface of the roller cooperates with the circumferentially extending inner surface of the housing adjacent the communicating recess to form the seal with the housing around the communicating recess.

152. A paint applicator as claimed in claim 151 in which the radius of the circumferentially extending inner surface of the housing from the main central axis thereof adjacent the communicating recess is not more than 1 mm greater than the radius of the paint transfer surface of the roller from the rotational axis thereof, and preferably, the radius of the circumferentially extending inner surface of the housing from the main central axis thereof adjacent the communicating recess is not more than 0.5 mm greater than the radius of the paint transfer surface of the roller from the rotational axis thereof, and advantageously, the radius of the circumferentially extending inner surface of the housing from the main central axis thereof adjacent the communicating recess is not more than 0.25 mm greater than the radius of the paint transfer surface of the roller from the rotational axis thereof, and preferably, the radius of the circumferentially extending inner surface of the housing from the main central axis thereof adjacent the communicating recess is not more than 0.1 mm greater than the radius of the paint transfer surface of the roller from the rotational axis thereof, and advantageously, the radius of the circumferentially extending inner surface of the housing from the main central axis thereof adjacent the communicating recess is substantially similar to the radius of the paint transfer surface of the roller from the rotational axis thereof, and preferably, the circumferentially extending inner surface of the housing extends circumferentially around the roller an angular distance in the range of 150° to 210°, and advantageously, the circumferentially extending inner surface of the housing extends circumferentially around the roller an angular distance in the range of 160° to 200°, and preferably, the circumferentially extending inner surface of the housing extends circumferentially around the roller an angular distance in the range of 170° to 195°, and advantageously, the circumferentially extending inner surface of the housing extends circumferentially around the roller an angular distance of approximately 195°, and preferably, the circumferentially extending inner surface of the housing extends circumferentially around the roller an angular distance of approximately 190°.

153. A paint applicator as claimed in claim 151 in which the circumferentially extending inner surface of the housing terminates at its respective circumferential opposite sides in longitudinal extending side edges defining the open mouth to the hollow interior region and exposing the paint transfer surface of the roller, and preferably, the longitudinally extending side edges defining the open mouth extend substantially parallel to each other, and substantially parallel to the rotational axis of the roller, and advantageously, the longitudinally extending side edges defining the open mouth extend substantially parallel to the main central axis, and preferably, the open mouth extends circumferentially around the roller an angular distance in the range of 150° to 210°, and preferably, the open mouth extends circumferentially around the roller an angular distance in the range of 160° to 200°, and advantageously, the open mouth extends circumferentially around the roller an angular distance in the range of 165° to 190°, and preferably, the open mouth extends circumferentially around the roller an angular distance of approximately 165°, and advantageously, the open mouth extends circumferentially around the roller an angular distance of approximately 170°, and preferably, the open mouth extends substantially the length of the roller.

154. A paint applicator as claimed in claim 149 in which the inlet port defines a central inlet axis, and preferably, the central inlet axis defined by the inlet port extends substantially perpendicularly to the rotational axis of the roller, and advantageously, the central inlet axis defined by the inlet port intersects the rotational axis of the roller, and preferably, the central inlet axis intersects the rotational axis of the roller substantially midway along the length of the roller, and advantageously, the central inlet axis substantially bisects the angle through which the circumferentially extending inner surface of the housing extends circumferentially around the roller.

155. A paint applicator as claimed in claim 149 in which the roller is rotatably mounted on a roller shaft, and preferably, the roller shaft extends longitudinally through the hollow interior region of the housing, and advantageously, the roller shaft defines the rotational axis of the roller, and preferably, the roller shaft is carried in the housing, and preferably, the roller shaft is carried in and extends between a pair of end walls longitudinally spaced apart along the rotational axis of the roller, and advantageously, the roller comprises a cylindrical drum defining an outer circumferential surface, and a paint transfer means defining the paint transfer surface located on and extending circumferentially around the outer circumferential surface of the cylindrical drum, and preferably, the paint transfer means comprises a fabric material, and advantageously, the paint transfer means comprises a fine mat material, and preferably, the paint transfer means comprises a high density knit fabric material.

156. A paint applicator as claimed in claim 149 in which the inlet port is configured for receiving a paint container, and for accommodating paint from the paint container to the communicating recess, and preferably, the paint container is coupled to the inlet port, and advantageously, the paint container is releasably coupled to the inlet port, and preferably, the paint container comprises an enclosed container having an outlet port configured for coupling to the inlet port of the housing, and advantageously, the outlet port of the container is configured for releasably coupling to the inlet port of the housing, and preferably, the container comprises one of a rigid and a semi-rigid material.

157. A paint applicator as claimed in claim 156 in which a support structure is provided for supporting the container, the support structure being located adjacent the inlet port, and preferably, the support structure extends from the housing around the inlet port, and advantageously, the support structure is configured for maintaining the container relative to the inlet port, so that the paint is fed from the container into the inlet port, and preferably, the support structure is configured for maintaining the container relative to the inlet port so that the paint is fed from the container into the inlet port under gravity, and advantageously, the support structure is releasably coupleable to the housing, and preferably, the container comprises a flexible material, and advantageously, the flexible material of the container is configured so that as the volume of paint in the container reduces, the internal volume of the container reduces substantially proportionally with the reduction in the volume of paint therein, and preferably, the flexible material of the container is configured so that the internal volume of the container remains substantially equal to the volume of paint therein.

158. A paint applicator as claimed in claim 149 in which the inlet port is formed by an inlet bore extending through the housing and communicating with the communicating recess, the inlet bore diverging outwardly into the communicating recess for distributing paint into the communicating recess.

159. A paint applicator as claimed in claim 149 in which the housing is carried on a carrier shaft.

160. A paint applicator as claimed in claim 159 in which the carrier shaft is releasably coupleable to the housing, and preferably, the carrier shaft is coupled to the housing at a location substantially midway between the ends of the roller, and advantageously, the carrier shaft terminates at a distal end thereof in a handgrip means, and preferably, the handgrip means comprises a first handgrip element extending longitudinally along a distal end of the carrier shaft, and advantageously, the handgrip means comprises a second handgrip element located adjacent the first handgrip element extending substantially transversely relative to the first handgrip element, and preferably, the second handgrip element is located between the carrier shaft and the first handgrip element, and advantageously, the second handgrip element is spaced apart radially from the carrier shaft, and preferably, a connecting means is provided for connecting the second handgrip element to the carrier shaft.

161. A paint applicator as claimed in claim 159 in which the carrier shaft is pivotally coupled to the housing about a first pivot axis, and the angular position of the carrier shaft relative to the housing is adjustable about the first pivot axis, and preferably, the first pivot axis extends substantially parallel to the central inlet axis defined by the inlet port, and advantageously, the carrier shaft comprises a proximal shaft portion and a distal shaft portion, the proximal shaft portion being coupled to the housing, and preferably, the distal shaft portion is pivotally coupled to the proximal shaft portion about a second pivot axis, and advantageously, the second pivot axis extends in a general direction at an angle greater than zero to the first pivot axis, and preferably, the second pivot axis extends orthogonally relative to the first pivot axis, and advantageously, the angular relationship of the distal shaft portion with the proximal shaft portion is adjustable about the second pivot axis, and preferably, the handgrip means is located on the distal shaft portion adjacent a distal end thereof.

162. A paint applicator comprising a housing defining a hollow interior region, a roller rotatably mounted in the housing about a longitudinally extending rotational axis and having a circumferentially extending paint transfer surface, the housing defining an open mouth providing access to the paint transfer surface of the roller, an inlet port in the housing to accommodate paint to the transfer surface of the roller, a paint container coupleable to the inlet port, the paint container cooperating with the inlet port for feeding paint from the container to the paint transfer surface of the roller.

163. A paint applicator as claimed in claim 162 in which the paint container is configured for feeding paint therefrom to the paint transfer surface of the roller under gravity, and preferably, the paint container comprises an enclosed container having an outlet port configured for coupling to the inlet port of the housing, and advantageously, the outlet port of the container is configured for releasably coupling to the inlet port of the housing, and preferably, the container comprises one of a rigid and a semi-rigid material.

164. A paint applicator as claimed in claim 162 in which a support structure is provided for supporting the container, the support structure being located adjacent the inlet port, and preferably, the support structure extends from the housing around the inlet port, and advantageously, the support structure is configured for maintaining the container relative to the inlet port, so that the paint is fed from the container into the inlet port, and preferably, the support structure is configured for maintaining the container relative to the inlet port so that the paint is fed from the container into the inlet port under gravity, and advantageously, the support structure is releasably coupleable to the housing.

165. A paint applicator as claimed in claim 164 in which the container comprises a flexible material, and advantageously, the flexible material of the container is configured so that as the volume of paint in the container reduces, the internal volume of the container reduces proportionally with the reduction in the volume of paint therein, and preferably, the flexible material of the container is configured so that the internal volume of the container remains substantially equal to the volume of paint therein.

166. A method for applying paint to a surface, the method comprising providing a paint applicator as claimed in claim 149, setting the carrier shaft relative to the housing, so that when the handgrip means is held for operating the paint applicator, the paint container is located above the housing, charging the paint container with paint and securing the paint container to the inlet port, urging the roller into engagement with the surface to be painted, and urging the roller along the surface to be painted, so that the roller rotates to transfer the paint from the paint container to the surface to be painted.

167. A method as claimed in claim 166 in which the paint applicator is configured for applying paint to an animal, and preferably, the paint applicator is configured for applying paint to one or both of a tail and a rear part of the back of the animal.

168. A method as claimed in claim 166 in which the paint applicator is configured for applying paint to an animal for detecting the onset of oestrus in the animal, and preferably, the animal is one of a cow and a heifer, and advantageously, the method further comprises periodically checking if the paint applied to the animal has been disturbed as a result of the animal having been mounted by another animal.
